(19) United States
(12) Patent Application Publication
(10) Pub. No.: US 2008/0033844 A1
(43) Pub. Date: Feb. 7, 2008

(54) Device and method for ordering customized balloon arrangements and tracking individual sales venue inventory over a network

(76) Inventor: Ken Stillman, San Jacinto, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/890,125

(22) Filed: Aug. 3, 2007

Related U.S. Application Data
(60) Provisional application No. 60/835,689, filed on Aug. 4, 2006.

(51) Int. Cl. G06F 17/30; G06Q 10/00; G06Q 30/00; G06Q 90/00

(52) U.S. Cl. 705/27; 705/26; 705/28

(57) ABSTRACT

A network or Web-based method employing software for assembling customized balloon arrangements. Remote graphic interfaces are provided to users allowing any of a plurality of user-specific requests for color, size, gas, and overall arrangement of the assembled balloons in a final chosen arrangement. Local delivery with exact renditions of the user-chosen arrangement are provided through communication of a colorized rendition of the user chosen arrangement a visual guide to assemble chosen arrangement for subsequent pick up or delivery by a receiving party. Additional software can track inventory depletion of vendors and national trends for balloon use to provide automatic ordering of replacement inventory.

This application claims priority from U.S. Provisional Patent Application Ser. No. 60/835,689 filed Aug. 4, 2006 and incorporated in its entirety hereto by reference.

### FIELD OF INVENTION

This invention relates generally to balloons. More particularly it relates to a user individualized customized balloon ordering system over a network or global communication network. The method and software provide a menu and icon driven graphical interface for balloon choices to the respective users allowing users and buyers to actually design the shapes, colors, inflation gas, and look of balloon arrangements, from a variety of available balloons in individual shapes and colors. The remotely user-customized and ordered display is then available for local delivery or pick up. Further the balloons employed by color and shape and type, are trackable on a national scale to replenish individual local inventories and to ascertain trends in orders so manufacturing and shipments may be matched to local and national requirements.

### BACKGROUND

Balloons are becoming more popular as gifts and decorations for celebrating events such as birthdays and graduations and the like. However, ordering balloon arrangements is a task that is not easily accomplished and lacks the ability for customization by the buyer of the resulting arrangement of balloons for color, size, shapes, and inflation gas type. Most arrangements if purchased, are accomplished so by searching out and finding a local purveyor of balloons and visiting the store in person for a purchase. Online purchases do exist but they lack the ability for the buyer to self-arrange the bouquet and customize the shapes, colors, and gas inflation of the resulting arrangements in an easy fashion. Further, there exists no manner for providing users and buyers with a graphic interface of different arrangement types, and balloon types, which may be included in a custom arrangement which allows the user to choose the colors, shapes, and floatation capability of the resulting balloons in the arrangement. Customers are thus left at the mercy of unimaginative local suppliers with limited stock, few ideas, and no manner to show the customer what the resulting arrangement will look like, even if the customer can choose balloons.

Additionally lacking is such a network or web-based system that will allow for custom customer ordering and then employing software adapted to the task, send the user-customized order to a local purveyor for delivery to the customer. Still further there is lacking any system that will track the usage of different balloon shapes, sizes and colors, and gases, and remote sales venues doing the custom arrangement, and thereafter initiate inventory replenishment automatically.

Accordingly, there is an unmet need for a device and method that will provide users with an intuitive graphic interface for customized balloon arrangements allowing users choice of size, color, shape, gas, and overall look of the arrangement over a network or world wide web-based system. Such a system should provide the user with a graphic interface of icons representative of the different balloon shapes and sizes for the user to assemble their desired customized arrangement, and to allow choice of color for each chosen balloon. The method should also provide standard arrangements where the user just chooses color, or individual balloon icons that can be arranged into a display by the user and colors chosen.

Still further such a device and method should employ software that will finalize the chosen arrangement and transmit the user customized order for local pickup and/or delivery. To make the system attractive to both local venues for balloon sales and balloon suppliers such a system should also communicate in real time the used or ordered balloons used so the vendor can reorder, and/or the supplier can receive reports from remote venues having software as to the number, color, shape, and type of balloons used. This real time information will spot trends and also aid in manufacturing and shipment of inventory replenishment to the individual vendors.

The system would work exceptionally well if a balloon manufacturer allowed the individual vendors of balloon arrangements to use an interface that allowed buyers to order on their individual websites, or, the software is set up on a remote server to accept orders from across the country. The orders would then be transmitted to the local supplier or vendor of the manufacturers products for sale of the arrangement and delivery to the local party for whom it was ordered. The manufacturer could thus provide ability of custom ordering of balloon arrangements, preferably using the manufacturer's balloons and supplies, to customers. This would give the manufacturer of the balloons something to provide balloon sales venue buyers in addition to just supplies making their products more attractive. Since the system can automatically ship inventory replenishment to local vendors based on inventory used, it also has the added benefit of inventory tracking to the local vendor, and automatic orders to the manufacturer.

### SUMMARY OF THE INVENTION

There is disclosed and described herein a software system adapted to run on networked computers enabling users or customers to individually design and order customized balloon displays over the world wide web. Unlike flower deliveries which are dependent on local stocks and seasonal supplies, balloons displays are capable of user designation of the individual balloons in a chosen display. Consequently unlike flower orders which must be done from predesignated arrangements due to the inventory available seasonably and locally, balloon arrangements are only limited by the user's imagination employing a plethora of different shapes and colors and gases for individual members of an assembled balloon display. However there is no current provision to allow users to designate and virtually assemble balloon displays for purchase and delivery.

The software and method that will provide buyers software generating a graphic interface on their computer display, allowing them to assemble and order a customized balloon arrangement, by size, color, shape, gas, and overall look of the arrangement, over a web-based system. The method may also provide both standard arrangements where the user just chooses color, or individual balloon icons that can be arranged into a display by the user and color chosen.

Once the user has finished customizing or ordering the balloon arrangement, the software will finalize the chosen arrangement, preferably generate a color rendition of the arrangement and the shapes, colors and sizes of the balloons chosen, along with indica identifying the balloons ordered and the intended party for the order, and communicate the color and balloon dimension rendition to a local vendor. The local vendor will thereafter employ the visual depiction of the customized order from the user, to assemble and arrange for local pickup and delivery of the customized balloon arrangement.

In the preferred mode, concurrently, on a national or network wide scale, a routine tracking of the balloons used and being ordered by customers will run to ascertain the different balloons used so the vendor can reorder or be automatically re-shipped new supplies. Additionally the manufacturer or supplier can receive real time or daily reports from the software which may be installed on local servers or on a server which transmits orders to local vendors, as to the number, color, shape, and type of balloons used, and thereafter automatically ship inventory replenishment to the individual vendors, and adjust manufacturing cycles for balloons being ordered in high volume.

The system would work best if a balloon manufacturer allowed the individual vendors of balloon arrangements to run software on their individual servers which would take orders from customers reaching their site. This is because most internet users are fairly savvy as to ordering from local vendors. However the software may also be housed on the manufacturers server and ascertain which vendor of the manufacturer should have the eventual order. This arrangement will allow a remote server to accept orders from across the country and then ascertain the local supplier of the arrangement and then transmit the user-customized balloon order with both a graphic reproduction and indicia as to delivery. The manufacturer could thus provide ability of remote user custom ordering of balloon arrangements, preferably using the manufacturer's balloons and supplies, to remote customers. This would give the manufacturer of the balloons something to provide buyers in addition to just balloon supplies and thereby give them a competitive advantage making their products more attractive to their buyer. Since the system can automatically ship inventory replenishment to local vendors based on inventory used, it also has the added benefit of inventory tracking for the local vendor, and automatic orders to the manufacturer.

The software can also track the individual balloons used by the local vendor and maintain a running inventory of said balloons of each local vendor which may be reported to them for accounting and ordering purposes and also to a balloon supplier so the supplier can ship additional balloons to said local vendor based on the reports of inventory used. Also the reports will enable the supplier to track trends which can develop in balloon use for colors and types of balloons for manufacturing projections and sales projections.

In this respect, before explaining at least one embodiment of the device and method herein in detail, it is to be understood that the invention is not limited in its application to the details of construction, and to the arrangement of the components or method steps set forth in the following description or illustrated in the drawings. The invention is thus capable of other embodiments and of being practiced and carried out in various ways and in a different order of execution. Also, it is to be understood that the phraseology and terminology employed herein are for the purpose of description and should not be regarded as limiting.

As such, those skilled in the art will appreciate that the conception, upon which the system and method are based, may readily be utilized as a basis for designing of other methods and software driven networked systems for carrying out the several purposes of the present invention. It is important, therefore, that the claims be regarded as including such equivalent construction insofar as they do not depart from the spirit and scope of the present invention.

It is an object of this invention to provide an intuitive graphic interface for balloon customers to customize balloon arrangements online, and order balloon arrangements over the world wide web.

It is a further object of this invention to provide such a system and allow the user to customize the assembled balloon display using icons and color charts to allow the user to form balloon arrangements with individual shapes, colors, sizes, and gas filling of the balloons.

An additional object of this invention is to provide such a system that issues color renditions of the ordered arrangements to local vendors for manufacture and tracks inventory for automatic ordering and shipments.

These together with other objects and advantages which will become subsequently apparent reside in the details of the construction and method as more fully hereinafter described and claimed, reference being had to the accompanying drawings forming a part thereof, wherein like numerals refer to like parts throughout.

### BRIEF DESCRIPTION OF DRAWING

FIGS. 1-5 depict different configurations users can arrange using a single shaped balloon and one or a plurality of colors and gases.

FIG. 5a depicts a graphic menu of available balloon shapes for the user to choose to assemble.

FIGS. 6-11 depict arrangements customized by the user choosing individual shapes from FIG. 5a and assembling the arrangement with colors and gases chosen also.

FIG. 12 depicts a graphical interface to choose balloon colors from a plurality of colors.

FIG. 13 depicts a graphical interface to choose gas type from a plurality of balloon inflation gases.

### DETAILED DESCRIPTION OF PREFERRED EMBODIMENTS

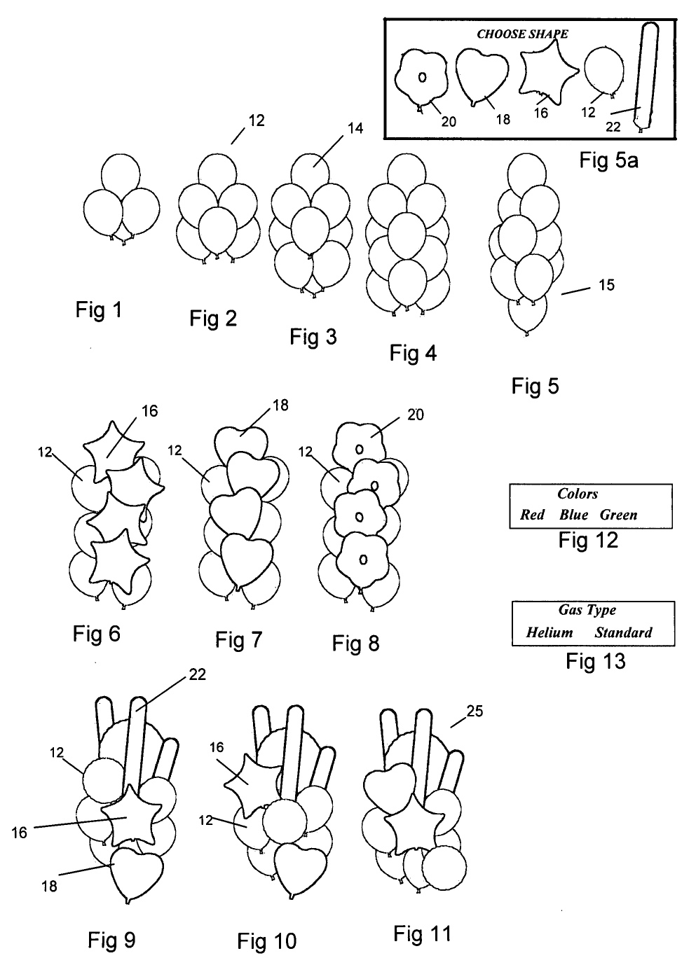

As noted, FIGS. 1-5 depicts an exemplar of user assembled graphic depictions from using a single balloon shape from the icons of FIG. 5a which depict the individual icons representing the shapes and sizes of balloons available in the online system. The available shapes and sizes is infinite and only limited by inventory available.

Using a mouse or pointing device to move a cursor the user will choose individual balloons from the plurality of iconic shapes such as those of FIG. 5a, and assemble a balloon arrangement using any of a plurality of iconic representations of the balloons available such as round balloons 14, stars 16, hearts 18 flowers 20, elongated balloons 22 or any other balloon shape and size which may be provided as an icon or drawing. Representative displays are shown in FIGS. 1-10 however those skilled in the art will realize the only limit on user assembly is the group of balloons offered in FIG. 5a for drag and drop to the assembly portion of the screen.

The colors offered such as those in FIG. 12 and gas type offered such as those of FIG. 13, can be chosen at the time of choosing of each balloon, or after assembly of an arrangement using software to associate a chosen balloon icon with a chosen gas or color clicked on by a cursor or otherwise designated and associated with a specific balloon.

The icons and assembly instructions may be displayed using networked software enabling buyers to design and order customized balloon displays (such as in FIGS. 1-11) over the world wide web. As noted, using iconic representation of different balloons and drag and drop arrangement assembly the software generates a graphic rendition on a computer display allowing users to drag the icons to form the desired arrangement and indicate the colors of each balloon and gas type. Once assembled, an order command will be provided such as a double-click on the assembled display or perhaps an order now button (not shown).

As noted, the outcome of the user assembled arrangement is only limited by the types of balloons offered in the plurality of balloons presented the user such as in 5a. Such arrangements can have round balloons 14, stars 16, hearts 18 flowers 20, elongated balloons 22, or any other type of individual balloons that might be sold to a buyer. The method may also provide both standard arrangements such as FIG. 11 which can just be assembled for them with little or no creativity by the user.

Once the user or buyer has finished customizing or ordering the balloon arrangement or display, and generated the signal provided by the software to finalize the order, the software will finalize the chosen arrangement, generate a color rendition of the arrangement and the shapes, colors and sizes and gases of the balloons chosen. In a next step, if the software is run on a nationally centralized server, a local venue for assembly and delivery will be determined and the order generated with the colorized depiction of the user assembled arrangement will be appropriately communicated to a local vendor for local pickup or delivery.

Tracking of the individual types of balloons from the available balloons such as shown in 5a, will be stored as used, so the vendor can be given a report on inventory reduction and reorder, or the supplier can receive reports from the software as to the balloons used by each venue and generate orders for replenishment of and the inventory used from the local vendor.

The software can also track the individual balloons used by the local vendor and maintain a running inventory of the available balloons of each local vendor which may be reported to them for accounting and ordering purposes and also to a balloon supplier so the supplier can ship or manufacture additional balloons to the local vendor based on the reports of inventory used. This real time tracking enables the generation of reports for the supplier to track balloon use trends which can develop for colors and types or shapes of balloons. These reports can then be employed for manufacturing projections and sales projections.

The balloon customization and ordering and tracking and method shown in the drawings and described in detail herein, features arrangements of elements of particular construction, and configurations for preferred embodiments of the present invention. It is to be understood, however, that elements of different construction and configuration and other arrangements thereof, other than those illustrated and described, may be employed for providing a device within the spirit of this invention.

As such, while the present system and method of the invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A method of assembling customized balloon arrangements using software communicating via a communication network and accommodating any of a plurality of user-specific requests for color, size, gas, and overall arrangement of the assembled balloons comprising the steps of:
providing a graphic interface to a user accessible display over a computer network;
providing graphic interface means for the user to designate individual balloons, from a plurality of balloons of different shapes or sizes, said individual balloons so designated to be included in a final balloon arrangement;
providing a graphic interface means for the user to designate an individual color for each of said individual balloons in said final balloon arrangement;
providing a graphic rendition of said final balloon arrangement for said user to approve as a chosen arrangement; and
communicating a colorized depiction of said graphic rendition of said chosen arrangement to a balloon vendor to employ as a visual guide to assemble said chosen arrangement for subsequent pick up or delivery by a receiving party.

2. The method of assembling customized balloon arrangements of claim 1 Additionally comprising:
providing a graphic interface means for the user to designate a gas to fill each of said individual balloons.

3. The method of assembling customized balloon arrangements of claim 1 comprising the additional step of:
ascertaining a geographic location for said receiving party for said chosen arrangement;
ascertaining a local said balloon vendor proximate to said geographic location; and
said communicating said colorized rendition of said chosen arrangement to said local said balloon vendor to assemble and tender to said receiving party is accomplished by electronic communication over a wide area network such as the Internet whereby said local said balloon vendor can thereafter assemble the exact chosen using balloons of the shapes and colors and sizes chosen by said user, and thereafter provide said chosen arraignment locally to said receiving party.

4. The method of assembling customized balloon arrangements of claim 2 comprising the additional step of:
acertaining a geographic location for said receiving party for said chosen arrangement;
acertaining a local said balloon vendor proximate to said geographic location; and
said communicating said colorized rendition of said chosen arrangement to said local said balloon vendor to assemble and tender to said receiving party is accomplished by electronic communication over a wide area network such as the Internet whereby said local said balloon vendor can thereafter assemble the exact chosen using balloons of the shapes and colors and sizes chosen by said user, and thereafter provide said chosen arraignment locally to said receiving party.

5. The method of assembling customized balloon arrangements of claim 3 comprising the additional steps of:
employing software for tracking usage of said individual balloons by said local said balloon vendor;
employing software for maintaining a current inventory of said balloons through deduction of said individual balloons used in said chosen arrangements; and
communicating reports of said inventory to one or both of said local said balloon vendor and a balloon supplier in reports, whereby either said balloon vendor or said supplier can employ said reports to initiate shipments of replacement said balloons to replenish said inventory.

6. The method of assembling customized balloon arrangements of claim 4 comprising the additional steps of:
employing software tracking usage of said individual balloons by said local said balloon vendor;
employing software maintaining a current inventory of said balloons through deduction of said individual balloons used;
employing software tracking usage of said gas used for inflating said individual balloons by said local said balloon vendor;
employing software maintaining a current inventory of said gas through deduction of said gas employed for filling said individual balloons; and
communicating reports of said current inventory of said balloons and said current inventory of said gas, to one or both of said local said balloon vendor and a balloon supplier in reports, whereby either said balloon vendor or said supplier can employ said reports to initiate shipments of replacement said balloons and said gas to replenish said inventory of balloons and said inventory of said gas.

7. The method of assembling customized balloon arrangements of claim 3 comprising the additional steps of:
employing said software for tracking usage of said individual balloons by said local said balloon vendor to also ascertain national trends for balloon use.

8. The method of assembling customized balloon arrangements of claim 3 comprising the additional steps of:
providing graphic interface means for the user to order standard arrangements requiring no user designation for individual balloons in said chosen arrangement.
